(19) United States
(12) Patent Application Publication
(10) Pub. No.: US 2012/0247436 A1
(43) Pub. Date: Oct. 4, 2012

(54) METHOD FOR TREATING COMBUSTION AIR FLOW IN A COMBUSTION PROCESS

(75) Inventors: Domenico Toneatto, Reinach AG (CH); Cataldo Volo, Mesenzana (VA) (IT); Gianmarco Malcotti, Porto Valtravaglia (VA) (IT)

(73) Assignee: PERISO SA, Isone (CH)

(21) Appl. No.: 13/516,508

(22) PCT Filed: Dec. 17, 2009
(86) PCT No.: PCT/IB2009/055828

§ 371 Date: Jun. 15, 2012

(51) Int. Cl. F02M 27/04; B03C 3/38

(52) U.S. Cl. 123/539; 95/57

(57) ABSTRACT

The invention describes a combustion process in which the combustion air (A*) is ionised by crossing a high voltage electric field, produced by a tube ioniser (12), before entering into the combustion chamber (C). It described a preferred application in which the air taken in by an internal combustion engine is ionised before entry into combustion chamber. In one of the aspects of the invention, the ionisation of the air is controlled to limit the generation of positive ions, obtaining a balancing between positive and negative ions.

### FIELD OF THE INVENTION

The invention concerns the field of combustion. In particular the invention concerns a method for decreasing the emission and therefore the environmental impact of a combustion process. In greater detail the invention concerns a method for treating a flow of combustion air in a combustion process.

### PRIOR ART

It is well known that the combustion of a fossil fuel produces a series of pollutants including nitrogen oxides NOx, sulphur oxides SOx, carbon monoxide, volatile organic compounds (VOC), residual hydrocarbons (HC) and particulate. These pollutants have a series of negative effects both on the environment and directly upon man. The combustion also produces carbon dioxide (CO₂), which is not a pollutant as such, since it derives from the total oxidation of carbon, but has been proven to be responsible for the well-known “greenhouse effect” with heavy environmental repercussions.

The formation of the aforementioned pollutants derives both from impurities in the fuel, for example in the case of sulphur oxides formation from sulphur contained in the gas or coal, and from the reactions involved in the combustion process, which is very complex. For example, residual hydrocarbons and particulate come from incomplete combustion of carbon, whereas the nitrogen oxides form through complex chemical reactions that involve nitrogen, inevitably present in the combustion air.

There are a series of remedies and provisions to attempt to reduce the environmental impact of a combustion process, which are generally based on the principle of treating the fumes so as to remove a certain pollutant, or else of modifying the combustion parameters, for example reducing the temperature with recycling of the exhaust gases, so as to prevent their formation. However, some of these provisions, for example desulphurisation and denitrification of the fumes, are expensive and complicated and can only be applied to large installations. However, it is known that many of the pollutants derive from even medium or small sized boilers (for example for heating), as well as from vehicle engines.

The previous treatment of the fuel (for example removal of sulphur, impurities, etc. . . . ) can exclusively be applied to large sized systems and still does not completely solve the problems outlined above. The treatment of combustion air, in the prior art, comprises the preheating of air, which is done to improve yield, and/or the possible dilution with a part of the exhaust gases, which can reduce the temperature peaks and reduce the formation of some pollutants, notably NOx.

Referring in greater detail to internal combustion engines for vehicles (both light and heavy), in recent years it has been attempted to tackle their environmental impact by adopting the catalytic treatment of the fumes, made necessary by increasingly stringent regulations. Diesel engines are, moreover, responsible for substantial particulate emissions, which it is attempted to reduce with a subsequent combustion of the fumes in so-called particulate filters. However, these filters are expensive and cannot always be applied to existing vehicles.

The particulate that is contained in the exhaust gases of an engine is correlated to the coefficient of opacity k that is correlated to the ratio between the intensity of an incident light and the intensity that pass through the fumes, for a defined linear path. For example, a method for measuring the coefficient of opacity is described in international standard ISO 11614:1999.

In general, the adoption of increasingly tough emissions standards brings a series of economic problems, including: increased cost of new automobiles, loss of value of second hand automobiles, and no possibility of access to historical centres with vehicles that do not meet the most recent standards.

Similar problems are encountered in the field of heat generation. It is known, for example, that an equally great contribution to atmospheric pollution comes from boilers and from heating systems.

### SUMMARY OF THE INVENTION

The problem forming the basis of the invention is to provide a simple, effective and low-cost system for reducing the environmental impact of combustion processes. The invention in particular proposes to provide a system that can be applied both in fixed installations, for example boilers, and in automobile engines.

The idea forming the basis of the present invention consists of an advance ionisation treatment of the combustion air, or at least of a part of the combustion air. A first aspect of the invention thus consists of a method for treating a flow of combustion air in a combustion process, characterised in that at least a part of said flow of combustion air is subjected to ionisation, obtaining a flow of ionised air, and said flow of ionised air is fed to said combustion process.

By the term combustion air, for the purposes of the present invention, it is intended atmospheric air or else air enriched with oxygen and/or possibly mixed with other gases, for example mixed with recycled exhaust gases. By the term “subject said flow of combustion air to ionisation”, it is intended that the flow of combustion air, or at least a part thereof, is subjected to an ionisation process before mixing and/or coming into contact with the fuel, and preferably before entry into the combustion chamber.

Said ionisation process is obtained by making at least a part of the flow of combustion air pass through an electric field of suitable intensity. For example, the flow of air licks at least one ioniser that produces an electric field and causes the ionisation of the air. The ionisation process, and in particular the ionisation of the air, is known and therefore is not described here in detail. The electrically neutral molecules (mainly O₂, N₂) of air are split into two or more parts (ions) with positive or negative electrical charges. The disassociation takes place by addition of energy. Preferably, according to the invention, the ionisation is caused through the generation of a suitable electric field.

In some embodiments of the invention, the flow of combustion air, or at least a part thereof, crosses an alternating electric field having direct or alternating high voltage, with a nominal value of some thousand volts, preferably between 2 and 5 kV and more preferably between 2 and 3 kV. In other embodiments, however, it is possible to adopt higher values, for example 9 kV. If the ionisation voltage is alternating, the oscillation frequency is preferably around 50 kHz; for example it is between 40 and 60 kHz and more preferably between 45 and 50 kHz. In particular, in application to Diesel cycle internal combustion engines, for use in automobiles; optimal results have been obtained with a tube ioniser, operating with nominal voltage of about 2500 V and frequency of about 50 kHz. The ioniser is arranged to intercept the flow of air taken in by the engine, preferably upstream of the airflow meter (air flow rate sensor).

An aspect of the invention consists of a control of the ionisation process of the air with the effect of limiting the generation of positive ions, to obtain positive and negative ions in a proportion suitable for the specific application, like for example a boiler or engine. A particular aspect of the invention consists of controlling the ionisation of the air to obtain a flow of ionised combustion air containing positive and negative ions in a predetermined proportion. The applicant has found that in known ionisation processes, the production of positive ions is substantially greater than the production of negative ions, also due to the fact that the average life of the positive ions is greater and can reach a few minutes, against an average life of a few seconds for negative ions. Therefore, an ioniser fed for example with symmetrical alternating voltage, tends to generate a flow of ionised air in which the production of positive ions exceeds an optimal value. Excessive production of positive ions can be harmful to man and also, in application to combustion, it has been found that ozone does not promote combustion since it is an inert gas.

An aspect of the invention consists of limiting the generation of positive ions, obtaining a predetermined proportion between positive and negative ions. The control of the ionisation process is obtained substantially with an attenuation or reduction of the positive component of the ionisation voltage, represented for example by the power supply voltage to an ioniser device, through a high voltage gate transformer. Preferably, the proportion is around 1:4, i.e. 2/10 of positive ions and 8/10 of negative ions.

Preferred embodiments are the following.

In a first embodiment, the ionisation device is fed by a high voltage gate transformer, and said transformer comprises a primary winding connected to a feeding circuit of the impulse type, and a secondary winding connected to at least one electrode of said ionisation device. Preferably, the primary winding of the transformer is connected to ground by means of at least one electronic switch, for example MOS-FET. In this way the closing of said switch induces current in the primary winding of the transformer, and the opening of said switch causes an impulse of current in the secondary winding and energy transfer to the ionisation device. The switch can be controlled with a square wave signal supplied by an oscillator.

The opening of the switch in greater detail is the equivalent to the transfer of one impulse of current, and thus of energy, to the secondary winding of the transformer and then to the ionisation device. The ionisation process takes place substantially during the rising front of said impulse. According to one of the aspects of the invention, the opening and closing frequency of the switch is such that the time period between two impulses is substantially the equal to the time necessary for transferring to the secondary winding the energy obtained from the passage of current in the primary during the closing time of the switch. The applicant has found that, in this way, the production of ions is mainly negative and the desired controlled bipolar ionisation effect is obtained.

In a possible version of construction, the ionisation device essentially comprises two electrodes separated by a body of dielectric material; one of said two electrodes is connected to earth and the other electrode is fed by said impulsive circuit.

According to another embodiment, the ionisation device, for example one of the electrodes of a tube ioniser, is fed with a voltage V(t) having alternating trend over time (t) with respect to a reference zero. Said voltage V(t) represents the signal that induces the ionisation of the air. According to some of the aspects of the invention, the RMS (Root Mean Square) value associated with the negative half-waves of said voltage V(t) is greater than the RMS value associated with the positive half-waves. Consequently, the energy transferred from the positive part of the voltage V(t) is less than the energy transferred by the negative part of the same function. Said voltage V(t) can be symmetrical or non-symmetrical with respect to the zero and have different waveforms; preferably, said voltage V(t) is substantially sinusoidal.

The described attenuation of the RMS value of the positive half-waves can be obtained for example in one of the following ways. In a first way, the function V(t) is asymmetrical with respect to zero, i.e. the peak values of the positive half-waves are lower (in absolute value) than the peak values of the negative half-waves. For example, the function V(t) is substantially a sinusoid shifted with respect to the line of the zero and towards the negative values. In a second way, a voltage V(t) symmetrical with respect to zero undergoes an attenuation of the positive half-waves, with a levelling of the positive peak values. It is possible to reduce the RMS value of the positive voltages through the attenuation of the positive half-waves of the voltage signal. Said attenuation can be obtained, for example, with a series of passive components comprising one or more resistances and at least one diode.

A second embodiment foresees an ionisation device comprising at least one electrode for the generation of positive ions, fed with a positive direct voltage, and at least one electrode for the generation of negative ions, fed with a negative direct voltage, said negative voltage having a higher absolute value than said positive voltage. For example, the ionisation device is of the needle type with one or more electrodes (needles) that receive the voltage of positive value and as many electrodes that receive the negative voltage.

In accordance with the invention, therefore, a circuit for controlling an ioniser comprises at least one high voltage gate transformer, connected to respective ionisation electrodes through a series of diodes and condensers suitable for amplifying the signal coming out from said transformer, and control means suitable for attenuating or reducing the positive component of the voltage delivered by said transformer. The aforementioned electrodes can be represented, in the various embodiments, by needles fed in direct voltage, or by electrodes or armatures of a tube ioniser.

With the methods described above, and relative circuits, the ionisation of the air is induced through the generation of an electric field in which the energy transfer associated with the positive voltage (in direct current or positive half-wave of a sinusoidal signal) is less than the energy transfer associated with the negative voltage. The production of positive ions is controlled, and the aforementioned balancing effect between positive and negative ions is obtained.

The applicant has noticed a surprising decrease in pollutants, following the advance ionisation treatment of the combustion air. Without wanting this to be taken in the limiting sense, it is believed that this is due to the formation of free radicals, induced by the ionisation process, which go enter the combustion chamber and prevent the formation of pollutants. It should be noted that ionisation is a per se known process, but up to now it has only been proposed for environmental treatment in closed spaces, offices, etc. . . . in order to improve air quality. In combustion processes, on the other hand, the prior art teaches generally to treat the combustion fumes, or else to treat the fuel in advance (desulphurisation, etc. . . . ). In contrast, the applicant has found that a significant advantage can be obtained with advance ionisation treatment of the combustion air. In the prior art, the combustion air is not generally treated or at most it is heated to increase yield.

Controlled bipolar ionisation, i.e. controlling the proportion between positive and negative ions, represents the preferred embodiment of the invention and has the further advantage of reducing the formation of ozone in the combustion chamber, as well as limiting the emission of positive ions, which have been found to have a harmful effect on health. However, this does not rule out the possibility of promoting the generation of ozone so as to obtain greater production of free radicals.

A preferred application consists of the ionisation of the air taken in by an internal combustion engine, even more preferably a diesel cycle engine. According to a particularly preferred aspect of the invention, an internal combustion engine comprises at least one ioniser that is located to act upon the flow of air taken in by the engine, preferably upstream of the airflow meter (if provided) that measures the flow rate of inlet air. The invention can advantageously be applied to automotive engines, both two and four stroke, Otto cycle, Diesel or other. Possible applications of the invention concern both motorcycles or light vehicles, and heavy vehicles. The invention can be applied to new vehicles or as an after market accessory to modify existing vehicles. A particularly advantageous application has been identified in Diesel cycle engines for automobiles, and particularly to reduce the emissions of particulate and the opacity of the fumes.

A particular aspect of the invention, therefore, consists of a method for modifying the system for feeding an internal combustion engine, characterised in that: at least one ioniser is arranged on the path of the air for feeding to said engine, so that said ioniser is hit by at least a part of the air taken in by the engine, and a control circuit of said ioniser is provided, adapted to control said ioniser to actuate an ionisation process of at least a part of the air taken in by the engine, as described above.

One of the aspects of the invention is represented by a kit for modifying an internal combustion engine of an automobile, comprising at least one ioniser adapted for installation on the path of the air for feeding said engine, and the suitable control circuit of said ioniser.

Advantages of the invention are low cost and ease of application. With reference to the field of automobiles, for example, the invention requires just that the intake of a conventional internal combustion engine be modified, with a low manpower cost. It can also be advantageously applied to the existing range of vehicles with much lower costs than known “retrofitting” systems that generally involve substantial modifications to the exhaust system. The described control system using voltage impulses, moreover, allows a so-called bipolar ionisation to be achieved, in which the ratio between positive ions and negative ions is kept within a predetermined range avoiding excessive production of ozone, which as known is a further polluting factor.

Another aspect of the invention consists of a boiler, an engine or another device that carries out a combustion process, for generating heat and/or mechanical or electrical energy, with a treatment of the combustion air as described above.

The characteristics and advantages of the invention shall become clearer from the following detailed description and with the help of the attached figures.

### BRIEF DESCRIPTION OF THE FIGURES

FIG. 1 shows a general diagram of an application of the invention.

FIG. 2 shows an air ionisation box made according to one of the aspects of the invention, able to be applied for example to an automobile engine.

FIG. 3 represents a possible circuit diagram of the tube ioniser of FIGS. 1 and 2, according to a preferred embodiment of the invention.

FIG. 3A represents the voltage signals in input to the control circuit of FIG. 3 and FIG. 3B gives an example of the operating principle of the impulse feeding circuit of FIG. 3.

FIG. 4 represents a circuit diagram according to another embodiment of the invention.

FIGS. 4A and 4B represent the voltage signals respectively in input to and output from the control circuit of FIG. 4.

FIG. 5 represents a circuit diagram according to a further embodiment of the invention.

FIGS. 5A and 5B represent the voltage signals respectively in input to and output from the control circuit of FIG. 5.

### DETAILED DESCRIPTION OF THE PREFERRED EMBODIMENTS

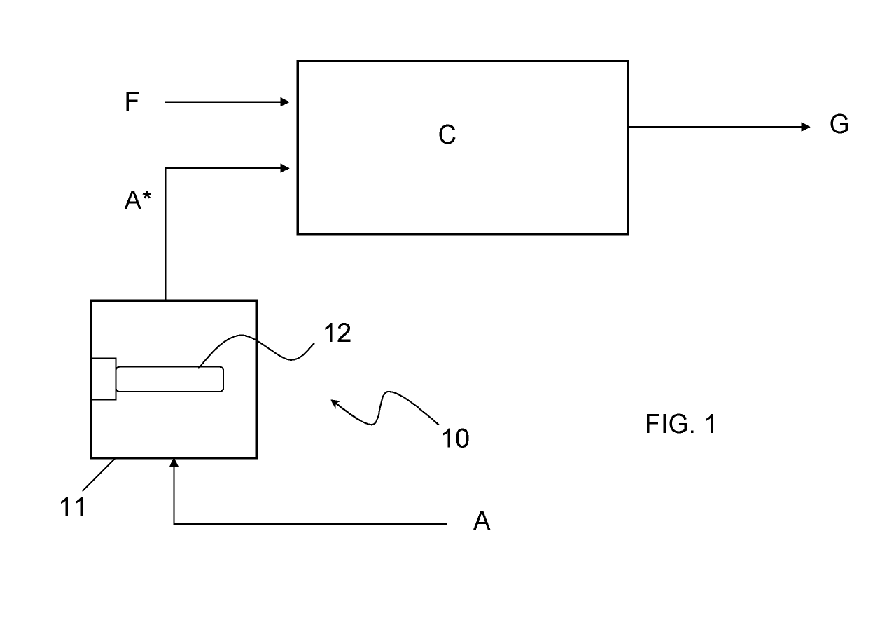

FIG. 1 schematically shows a combustion chamber C that receives a flow of fuel F and a flow of combustion air A* ionised in advance in a device indicated as 10. The combustion chamber C can be represented, for example, by the combustion chamber of a boiler, for example for the production of hot water, heating, etc. . . . or else by the combustion chamber of an internal combustion engine. Coming out from the combustion chamber C there is a flow of exhaust gases G.

The device 10, in the example of FIG. 1, is schematised as a box 11 inside of which a tube ioniser 12 is provided. Said ioniser 12 acts upon inlet flow of air A producing the flow of ionised air A*. Said flow A, going into the device 10, can be taken in from the outside possibly filtered or mixed with recycled burnt gases.

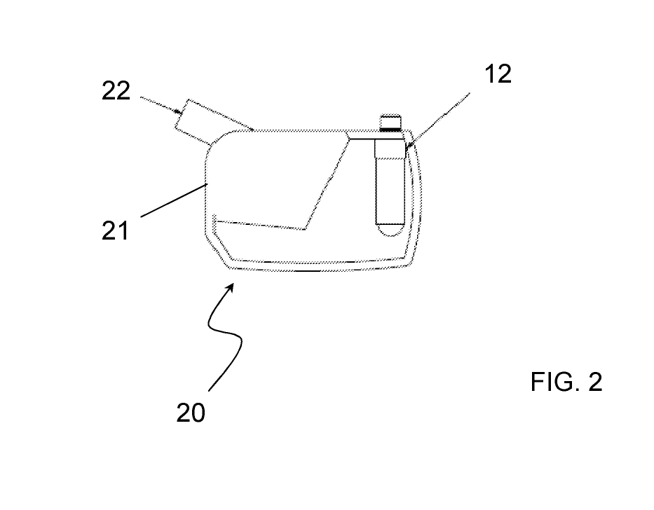

A preferred application is shown in greater detail in FIG. 2. Said FIG. 2 shows an air ionisation box 20 able to be applied for example to an automobile engine. Said box has a body 21 with an air intake 22, and carries a tube ioniser indicated, as in the previous case, with 12. The box 20 can be mounted in the engine compartment, so as to intercept the flow of air taken in by the engine itself.

Said ioniser 12 is sized in proportion to the power of the engine. It has been found that a tube ioniser with a diameter of about 10 mm and a length of 45 mm is suitable for low power engines, up to about 90 HP; an ioniser 120 mm long and having a diameter of about 50 mm is suitable for medium power engines, up to about 150 HP, and an ioniser 195 mm long is suitable for engine over 150 HP. Such numerical values are provided as a guide and not for limiting purposes.

Hereafter some preferred embodiments of the invention are described in detail.

### First Embodiment

The ioniser 12 comprises a substantially cylindrical tube 100, made of quartz or another insulating dielectric material. The tube is equipped with an inner plate 101 and with an outer mesh 102 both made from electrically conducting material, for example metallic. Said plate 101 and mesh 102 basically form the armatures of a condenser and extend substantially for the entire length of the tube 100. The mesh 102 is connected to earth, whereas the other armature, i.e. the plate 101, is connected to one end of a secondary winding 103 (at high voltage) of a high voltage gate transformer T. Said winding 103, at the opposite end, is earthed.

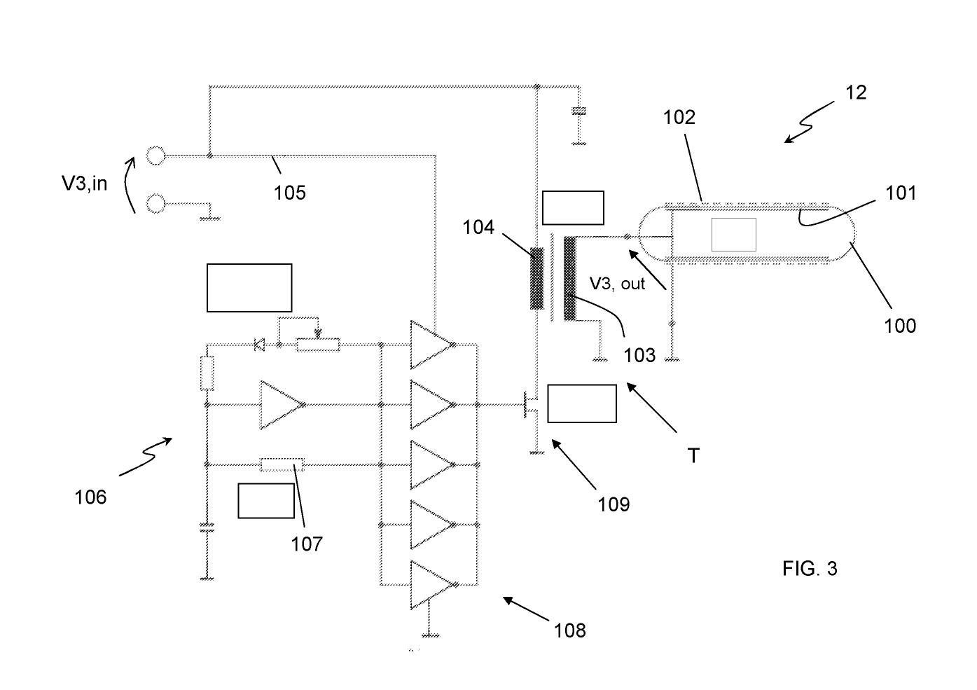

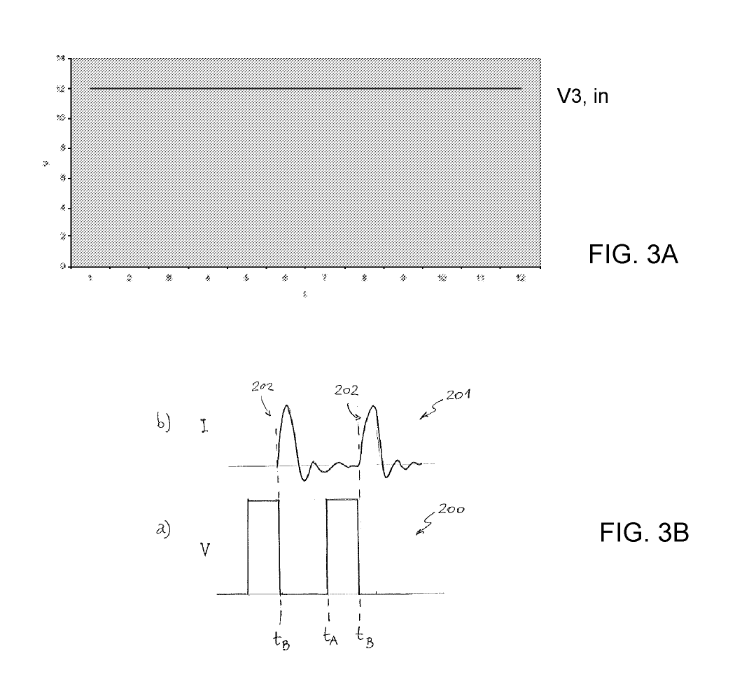

Said transformer T is connected to an impulse feeding circuit 106, which is substantially based on the use of an electronic switch 109. When said switch 109 is closed, the primary of the transformer is crossed by an electric current; when the switch is open, there is energy transfer to the secondary and to the ioniser device connected to it. In greater detail, the primary winding 104 of said transformer T is connected to a feeding line 105 in low direct voltage (12V) and to a control circuit 106 that essentially comprises a square wave oscillator 107, a driver stage 108 and an electronic MOS switch 109. Said switch 109 has a closing time given by the positive impulse of the square wave generated by the oscillator. The input signal V_{3,in} at 12 VDC is shown in FIG. 3A.

FIG. 3B shows the square wave 200 of the oscillator that makes the switch 109 close (graph a), and the curve 201 that represents the current in the secondary winding of the transformer T (graph b). The closing (conduction) time of the switch 109 corresponds in FIG. 3B to the time period between times t_{A} and t_{B}. At time t_{B} the feed to the transformer is interrupted and a rising front 202 of the curve 201 is generated, corresponding to the passage of energy to the ioniser device 12 and thus to the actual ionisation process. The opening and closing frequency of the switch is preferably such that the time period between two impulses, i.e. between two successive openings of the switch that generate the rising fronts 202, is substantially equal to the time period necessary for the complete energy transfer from the primary to the secondary.

Preferably, the device integrated in the circuit diagram of FIG. 3 is model HEF40106BP produced by Philips; the MOS-FET switch is an IRFZ44NL produced by International Rectifier. In the diagram of FIG. 3 the symbols known to the man skilled in the art are used, and therefore any further description is not considered to be necessary.

The control circuit advantageously comprises a voltage control in case there are overvoltages that could damage the system (for example, up to 16 VDC with a nominal voltage of 12 VDC), and it also comprises a trimmer for adjusting the oscillation frequency.

### Second Embodiment

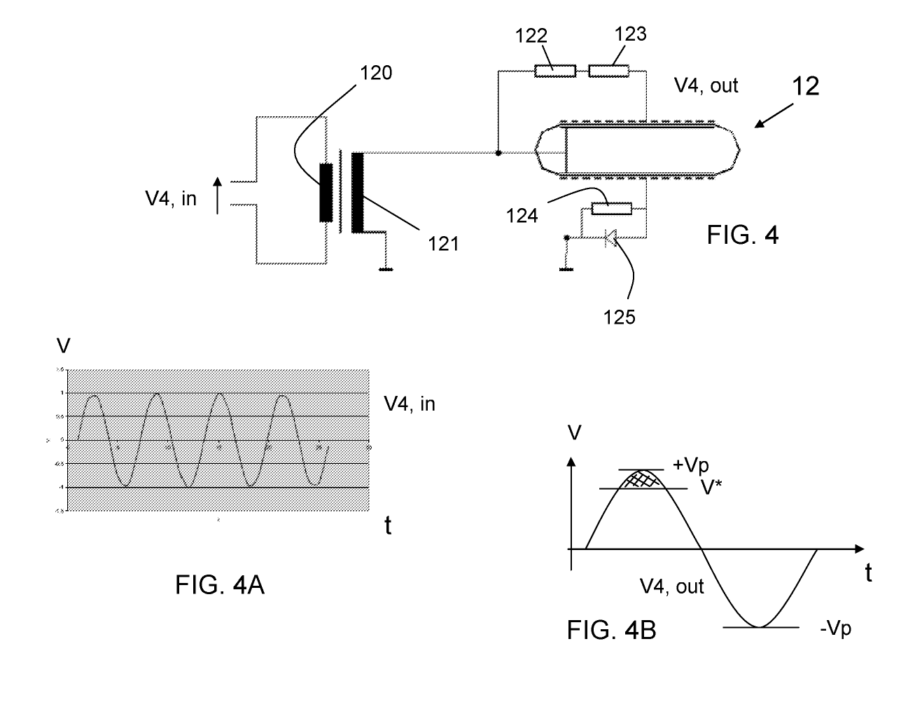

With reference to FIG. 4, the ioniser 12 is structurally similar to that of the example of FIG. 3, comprising a tube 100 made from insulating material, an inner plate 101 and an outer mesh 102. The voltage is supplied by a high voltage gate transformer, in which the primary 120 receives an alternating sinusoidal voltage V_{4,in} like in FIG. 4A, and the secondary 121 supplies a voltage V_{4,out} with levelling of the positive peaks (FIG. 4B) obtained through resistances 122, 123, 124 and diode 125. By means of said passive components 122-125, the positive half-wave is levelled at a maximum value V* that is below the peak voltage value Vp of the S-shape. The peak area indicated with a broken line in FIG. 4B is “cut” by the signal and, consequently, the RMS voltage value of the positive half-wave is less than the RMS voltage value of the negative half-wave, analogously to the signal of FIG. 3B. For example, the input signal of FIG. 4A is at 220 VAC and the signal of FIG. 4B reaches 2.7 kVAC.

It should be understood that both in the embodiment of FIG. 3 and in that of FIG. 4, the energy transferred from the positive half-wave is less than that transferred from the negative half-wave.

### Third Embodiment

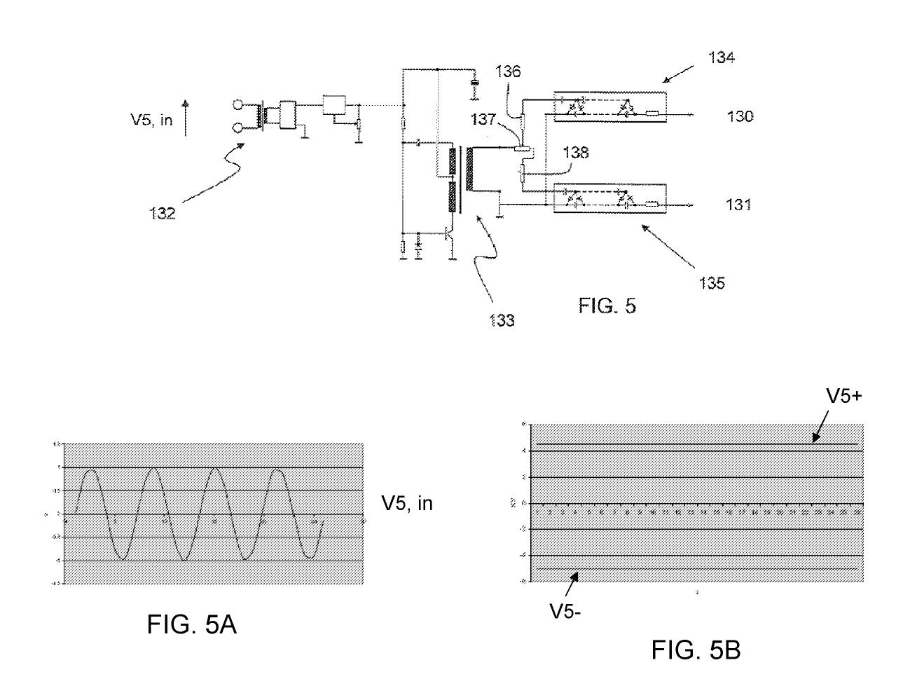

An ioniser with needles (FIG. 5) comprises an electrode or needle, or else a respective plurality of needles, connected to a positive pole 130, and correspondingly one or more needles connected to a negative pole 131. A supply voltage of 220 VAC or else a direct voltage of 12 VDC is raised in a first boosting transformer 132 and then is raised further in a transformer 133 and rectified with series of condensers and diodes 134, 135, obtaining a continuous output signal (DC). These details are per se known and therefore are not described in detail. By means of suitable trimmers 136, 137 and 138, the output signal available at the poles 130 and 131 is adjusted by attenuating the level of the positive voltage at the pole 130. For example, an input signal according to FIG. 5A at 220 VAC provides an output signal of 4.5 kV DC of positive voltage (V5+), and 5 kV DC of negative voltage (V5−).

With reference to the aforementioned embodiments, the electric field that is established, during operation, between the electrodes such as the plate 101 and the mesh 102 (FIG. 3, 4) or else the needles connected to the poles 130 and 131 (FIG. 5), ionises the flow of air that licks the tube 100, freeing a substantial amount of ions. The air thus ionised, going into the combustion chamber of the engine, allows easier ignition of the combustion agent and the presence of free radicals generated by the ionised air predisposes the molecules (air mixed with the combustion agent) to create aggregations with less fixed particulate residue (NO_{X}, SO_{X}, CO). The benefits are seen in the lower consumption of the vehicle and better response of the engine when starting up.

### EXAMPLE

An automobile model Opel Astra GTC 150 HP was subjected to opacity tests of the exhaust fumes. Then the vehicle was modified with the addition of a tube ioniser of 120 mm, nominal voltage between the armatures of 2500 V (3500 V peak) and oscillation frequency equal to 47.2 kHz. The ioniser was inserted on the path of the feeding air upstream of the airflow meter, so as to intercept substantially all of the flow of air taken in by the engine. The ioniser was housed in a box of the type depicted in FIG. 2, and the box was arranged in the engine compartment. The ioniser generates about 50,000 ION-/cm³ (negative ions per cm³) and about 10,000 ION+/cm³.

The coefficient of opacity k was measured with an opacimeter BOSCH® 430 obtaining the following results.

Without ionisation device: an opacity test of the fumes at the time of the regular maintenance inspection, showed values of the constant k of between 0.77 and 0.91. A second test, without ionisation device, carried out about 40 days later showed values of the constant k of between 1.11 and 1.57. Then an ionisation device of the type described in the present application was mounted. Roughly two months after the opacity test, again carried out with the same instrument, showed the following values:
with ionisation device: coefficient of opacity k between 0.04 and 0.07;
without ionisation device: coefficient of opacity k between 0.17 and 0.23.

Considering this data, it can be seen that using the vehicle for a certain time with the air ionisation system according to the invention gives a drastic reduction in the opacity of the exhaust fumes and therefore in the emission of particulate. It has been found that the ionisation of the combustion air gives a “cleaning” effect of the combustion chambers, and therefore less particulate in the fumes, which manifests itself over time and that remains for a certain time even removing the device. It has also been found that there is an improvement in performance of the vehicle, due to the fact that the engine manages to deliver the maximum torque at lower revs than what is stated by the manufacturer, and therefore the vehicle accelerates faster. A consumption test has also shown a decrease in consumption. Over a journey of about 600 km, the following consumption values were recorded:
with ionisation device: about 5.2-5.7 litres/100 km
without ionisation device: about 6.7-6.8 litres/100 km.

1. A method for treating a flow of combustion air (A) in a combustion process, characterised in, that at least a part of said flow of combustion air (A) is subjected to ionisation, obtaining a flow of ionised air (A*), and said flow of ionised air is fed to said combustion process.

2. A method according to claim 1, wherein said at least a part of the flow of combustion air (A) is subjected to ionisation upstream of the entry into a combustion chamber (C), obtaining said flow of ionised air (A*).

3. A method according to any one of the previous claims, wherein said at least a part of the flow of combustion air is subjected to ionisation crossing a high voltage alternating electric field.

4. A method according to any one of claims 1 to 3, wherein the ionisation of the air is controlled to limit the generation of positive ions, obtaining a predetermined proportion between positive and negative ions.

5. A method according to claim 4, wherein the ionisation device (12) is fed by a high voltage gate transformer (T), and said transformer comprises a primary winding (104) connected to a supply circuit (106) of the impulse type, and a secondary winding (103) connected to at least one electrode (101) of said ionisation device.

6. A method according to claim 5, wherein the primary winding (104) of the transformer is connected to earth by means of at least one electronic switch (109), so that the closing of said switch induces current in the primary winding of the transformer, and the opening of said switch causes an impulse of current in the secondary winding and energy transfer to the ionisation device.

7. A method according to claim 6, wherein the frequency of opening and closing of the switch is such that the time period between two impulses is substantially equal to the time period necessary to transfer to the secondary winding the energy obtained from the passage of current in the primary during the closing time of the switch.

8. A method according to claim 4, comprising an attenuation or reduction of the positive component of the ionisation voltage, to obtain said limitation of the generation of positive ions.

9. A method according to claim 8, wherein the air is ionised with at least one ionisation device, that comprises two electrodes (101, 102) separated by a body of dielectric material (100); one of said two electrodes (102) is connected to earth and the other electrode (101) is fed with a voltage V(t) having an alternating value over time with respect to a zero voltage, wherein the RMS value (N_{eff,-}) associated with the negative half-waves of said voltage V(t) is greater than the RMS value (N_{eff,+}) associated with the positive half-waves.

10. A method according to claim 9, wherein: the electrode (101) under voltage is connected to the secondary winding (121) of a high voltage gate transformer, and the positive half-waves of the voltage signal supplied to said electrode are attenuated through passive components (122-105) obtaining a levelling of the peak values of the positive half-waves.

11. A method according to any one of the previous claims, said ionisation device being of the tube type, comprising a dielectric tube and two electrodes respectively inside and outside said tube.

12. A method according to claim 4, wherein the air is ionised with at least one ionisation device that comprises at least one electrode for the generation of positive ions, fed with a positive direct voltage, and at least one electrode for the generation of negative ions, fed with a negative direct voltage, said negative voltage having a higher absolute value than said positive voltage.

13. A method according to any one of claims 4 to 12, said proportion preferably being about 1:4, i.e. 2/10 of positive ions and 8/10 of negative ions.

14. A method according to any one of the previous claims, the voltage of the electric field that causes the ionisation of the air being of nominal value between 2 and 5 kV and more preferably between 2 and 3 kV.

15. A method according to claim 14, said electric field having an oscillation frequency of between 20 and 60 kHz and more preferably between 45 and 50 kHz.

16. A method according to any one of the previous claims, wherein:
said combustion process is the combustion process in a diesel cycle internal combustion engine;
the ionisation of the combustion air takes place with a tube ioniser (12), operating with a nominal voltage of about 2500 V and frequency of about 50 kHz.

17. A method for modifying an internal combustion engine of an automobile, characterised in that:
at least one ioniser (12) is provided on the path of the air (A) for feeding to said engine, so that said ioniser is hit by at least one part of the air taken in by the engine,
a control circuit (106) of said ioniser is provided, adapted to control said ioniser to actuate an ionisation treatment of at least one part of the air taken in by the engine, according to any one of the previous claims.

18. A kit for modifying the feeding system of an internal combustion engine of an automobile, comprising at least one ioniser adapted for installation on the path of the feeding air of said engine, and a control circuit of said ioniser, for actuating an ionisation treatment of at least one part of the air taken in by the engine, according to any one of the previous claims.

19. An automobile comprising an internal combustion engine and at least one ioniser installed on the path of the feeding air of said engine, and a control circuit of said ioniser, for actuating an ionisation treatment of at least one part of the air taken in by the engine, according to any one of the previous claims.
